(19) United States
(12) Patent Application Publication
(10) Pub. No.: US 2026/0259549 A1
(43) Pub. Date: Sep. 3, 2026

(54) SYSTEMS AND METHODS FOR EMERGENCY SUPERVISION OF STORMWATER INLETS IN SMART CITY BASED ON INTERNET OF THINGS (IOT) LARGE MODEL

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN); Siwei ZENG, Chengdu (CN)

(73) Assignee: CHENGDU QINCHUAN IOT TECHNOLOGY CO., LTD., Chengdu (CN)

(21) Appl. No.: 19/658,783

(22) Filed: Apr. 27, 2026

(30) Foreign Application Priority Data
Apr. 3, 2026 (CN) 202610433959.7

(51) Int. Cl. G05B 19/4155

(52) U.S. Cl. CPC G05B 19/4155; G05B 2219/45072

(57) ABSTRACT

Disclosed is system and method for emergency supervision of stormwater inlets in a smart city based on an IoT large model. The method includes determining blocked stormwater inlet and unblocked stormwater inlet based on real-time water accumulation data of the stormwater inlets; acquiring a water accumulation data sequence of the blocked stormwater inlet, and determining a water accumulation growth feature of the blocked stormwater inlet; determining a first cleaning point and its first priority level; determining a blockage probability distribution of the unblocked stormwater inlet; and determining a second cleaning point based on the blockage probability distribution; and generating a cleaning instruction including a cleaning path and a cleaning sequence based on the first cleaning point, the first priority level, and the second cleaning point, and controlling an autonomous cleaning machine to move along the cleaning path and to perform cleaning on corresponding stormwater inlets based on the cleaning sequence.

### CROSS-REFERENCE TO RELATED APPLICATIONS

This application claims priority to Chinese Patent Application No. 2026104339597, filed on Apr. 3, 2026, the contents of which are hereby incorporated by reference to its entirety.

### TECHNICAL FIELD

The present disclosure generally relates to a field of road monitoring, and in particular to a system and a method for emergency supervision of stormwater inlets in a smart city based on an Internet of Things (IoT) large model.

### BACKGROUND

In an urban drainage system, rainwater grates (also known as stormwater inlets) play a key role in collecting surface runoff. However, during the leaf fall season, under strong wind conditions, or in areas near construction sites, stormwater inlets are highly susceptible to being covered or blocked by debris such as leaves, garbage, and silt. This blockage prevents rainwater from entering the underground drainage pipe network in a timely manner and is one of the important causes of water accumulation on urban roads.

Existing blockage monitoring and handling methods mainly rely on manual inspections or deployment of isolated sensors. Manual inspections are inefficient, have limited coverage, and pose safety risks, making it difficult to detect and locate sudden blockages in a timely manner. Data from isolated sensors is difficult to accurately distinguish the cause of water accumulation and is even less effective in identifying the nature and extent of blockage coverage. This leads to delayed responses, make it impossible to conduct accurate risk assessment and predictive maintenance under complex and variable environmental conditions, and passive cleanup work often starts only after water accumulation has already formed.

Therefore, it is desirable to provide a system and a method for emergency supervision of stormwater inlets in a smart city based on an IoT large model, which can effectively prevent and solve road water accumulation problems caused by stormwater inlet blockages.

### SUMMARY

One or more embodiments of the present disclosure provide a system for emergency supervision of stormwater inlets in a smart city based on an IoT large model. The system for emergency supervision of stormwater inlets in the smart city based on an IoT large model includes an emergency supervision management platform. The emergency supervision management platform is configured to execute a method for emergency supervision of stormwater inlets in the smart city.

One or more embodiments of the present disclosure provide a method for emergency supervision of stormwater inlets in a smart city. The method is executed by an emergency supervision management platform of a system for emergency supervision of stormwater inlets in a smart city based on an IoT large model. The method comprises: determining at least one blocked stormwater inlet and at least one unblocked stormwater inlet based on real-time water accumulation data of the stormwater inlets; acquiring a water accumulation data sequence of the at least one blocked stormwater inlet, and determining a water accumulation growth feature of the at least one blocked stormwater inlet based on the water accumulation data sequence; determining a first cleaning point and a first priority level corresponding to the first cleaning point based on the water accumulation growth feature; determining a blockage probability distribution of the at least one unblocked stormwater inlet; and determining a second cleaning point based on the blockage probability distribution; and generating a cleaning instruction based on the first cleaning point, the first priority level, and the second cleaning point, wherein the cleaning instruction includes a cleaning path and a cleaning sequence, and the cleaning instruction is configured to control an autonomous cleaning machine to move along the cleaning path and to perform cleaning on stormwater inlets corresponding to the first cleaning point and the second cleaning point respectively based on the cleaning sequence.

One or more embodiments of the present disclosure provide a non-transitory computer-readable storage medium. The storage medium stores computer instructions, wherein when a computer reads the computer instructions in the storage medium, the computer executes the method for emergency supervision of stormwater inlets in a smart city.

### BRIEF DESCRIPTION OF THE DRAWINGS

The present disclosure is further illustrated in a manner of exemplary embodiments, and the exemplary embodiments are described in detail with reference to the accompanying drawings. The embodiments are not limiting, and in the embodiments, the same reference numerals denote the same structures, wherein:

FIG. 1 is a schematic diagram illustrating an exemplary system for emergency supervision of stormwater inlets in a smart city based on an IoT large model according to some embodiments of the present disclosure;

FIG. 2 is a flowchart illustrating an exemplary method for emergency supervision of stormwater inlets in a smart city according to some embodiments of the present disclosure;

FIG. 3 is a schematic diagram illustrating an exemplary blockage prediction model according to some embodiments of the present disclosure;

FIG. 4 is a flowchart illustrating an exemplary process for adjusting a cleaning path according to some embodiments of the present disclosure;

FIG. 5 is a flowchart illustrating an exemplary process for generating a warning instruction according to some embodiments of the present disclosure.

### DETAILED DESCRIPTION

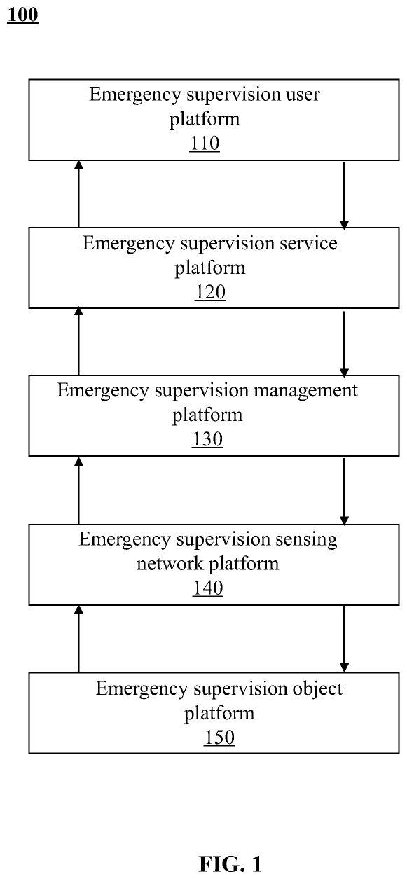

FIG. 1 is a schematic diagram illustrating an exemplary system for emergency supervision of stormwater inlets in a smart city based on an IoT large model according to some embodiments of the present disclosure.

In some embodiments, as shown in FIG. 1, the system for emergency supervision of stormwater inlets in a smart city based on an IoT large model 100 includes an emergency supervision user platform 110, an emergency supervision service platform 120, an emergency supervision management platform 130, an emergency supervision sensing network platform 140, and an emergency supervision object platform 150 that are sequentially connected. In some embodiments, one or more platforms in the system for emergency supervision of stormwater inlets in a smart city based on an IoT large model 100 may exchange information and/or data via a network. In some embodiments, the network may be any one or more of a wired network or a wireless network.

The emergency supervision user platform 110 refers to a platform for interacting with a user. In some embodiments, the emergency supervision user platform 110 may be configured to provide data visualization and warning push notifications. In some embodiments, the emergency supervision user platform 110 may include various mobile terminal devices.

In some embodiments, the emergency supervision user platform 110 may perform data interaction with the emergency supervision management platform 130 via the emergency supervision service platform 120. For example, the emergency supervision user platform 110 may obtain supervision data information uploaded by the emergency supervision management platform 130, or the emergency supervision user platform 110 may issue a monitoring demand instruction to the emergency supervision management platform 130.

The emergency supervision service platform 120 refers to a platform for conveying user instructions and control information. The emergency supervision service platform 120 may perform data interaction with the emergency supervision user platform 110 and the emergency supervision management platform 130.

The emergency supervision management platform 130 refers to a platform for supervising and managing data related to the system for emergency supervision of stormwater inlets in the smart city based on an IoT large model 100. The emergency supervision management platform 130 may perform data interaction with the emergency supervision service platform 120 and the emergency supervision sensing network platform 140.

In some embodiments, the emergency supervision management platform 130 may include a processor and a storage device.

In some embodiments, configuration contents of the emergency supervision management platform 130 may be found in the foregoing description regarding the method for emergency supervision of stormwater inlets in the smart city.

The emergency supervision sensing network platform 140 refers to a functional platform for sensing communication. In some embodiments, the emergency supervision sensing network platform 140 may be configured as a communication network, a gateway, or the like.

In some embodiments, the emergency supervision sensing network platform 140 may interact with the emergency supervision management platform 130 and the emergency supervision object platform 150 to implement functions of transmitting data such as real-time water accumulation data, vegetation data, urban management data, and weather data. For example, the emergency supervision sensing network platform 140 may receive real-time water accumulation data uploaded by the emergency supervision object platform 150, or issue a scheduling instruction or a data acquisition instruction to the emergency supervision object platform 150.

The emergency supervision object platform 150 refers to a functional platform for acquiring data or executing instructions. In some embodiments, the emergency supervision object platform 150 may include devices such as a water accumulation sensor, a high-definition camera, an unmanned aerial vehicle (UAV), and an autonomous cleaning machine.

The water accumulation sensor refers to a device for monitoring a water accumulation depth on a surface of the stormwater inlet or inside a pipe in real time.

The high-definition camera is configured to capture real-time images of the stormwater inlet around the clock and upload captured data to the emergency supervision management platform 130 for analysis.

The UAV is configured to acquire multi-view high-definition images according to a preset shooting angle and a preset focal length for supplementing data and re-determining a blockage probability distribution of the stormwater inlet. More descriptions regarding the blockage probability distribution of the stormwater inlet may be found in step 240 and related descriptions.

The autonomous cleaning machine refers to a device configured to receive a cleaning instruction from the emergency supervision management platform 130 and execute a cleaning task. The autonomous cleaning machine may include a light-duty wheeled cleaning robot, a heavy-duty tracked cleaning machine, a micro pipeline robot, or the like. In some embodiments, the autonomous cleaning machine receives the cleaning instruction from the emergency supervision management platform 130 and removes a blockage object via a mechanical arm or other composite structure.

In some embodiments of the present disclosure, based on the system for emergency supervision of stormwater inlets in a smart city based on an IoT large model 100, an information operation closed loop can be formed among various platforms. These platforms operate in a coordinated and regular manner under unified management of the system for emergency supervision of stormwater inlets in a smart city based on an IoT large model, thereby achieving informatization and intelligence of management of urban stormwater inlets and water accumulation problems.

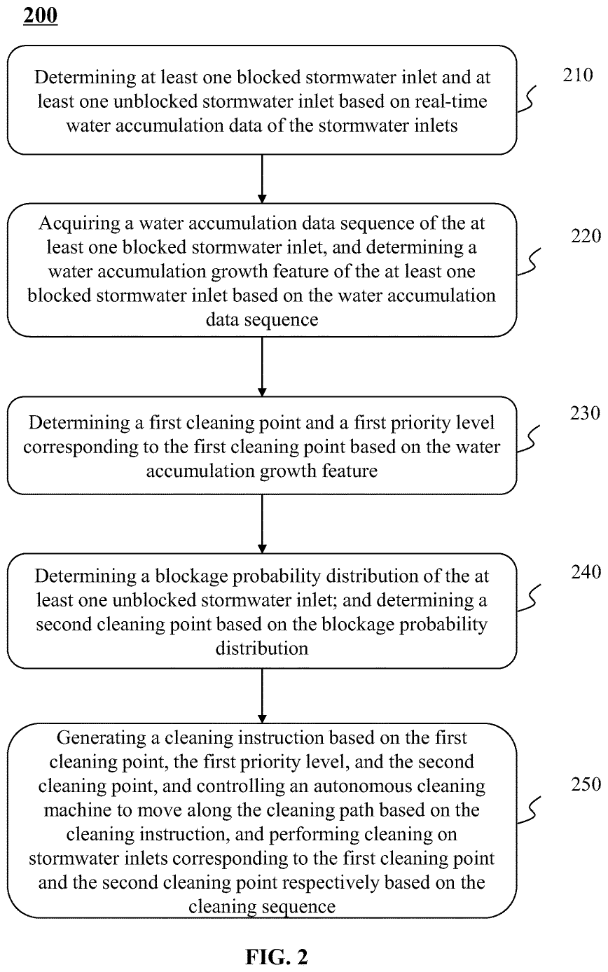

FIG. 2 is a flowchart illustrating an exemplary method for emergency supervision of stormwater inlets in a smart city according to some embodiments of the present disclosure. As shown in FIG. 2, process 200 includes the following steps. In some embodiments, process 200 may be executed by the emergency supervision management platform.

Step 210, determining at least one blocked stormwater inlet and at least one unblocked stormwater inlet based on real-time water accumulation data of the stormwater inlets.

The stormwater inlet refers to a facility in an urban pipe network drainage system for collecting and discharging surface rainwater. In some embodiments, each stormwater inlet is provided with a unique identification (ID). In some embodiments, a stormwater inlet includes an inlet grate, a well body, a branch pipe, or the like.

The real-time water accumulation data refers to real-time data of water accumulation around the stormwater inlet. For example, water accumulation depth, water accumulation area, or the like.

In some embodiments, the real-time water accumulation data may be continuously collected by water accumulation sensors deployed around the stormwater inlet.

The blocked stormwater inlet refers to a stormwater inlet that loses a drainage function due to blockage. The unblocked stormwater inlet refers to a stormwater inlet that is clear inside and has a normal drainage function.

In some embodiments, the emergency supervision management platform may determine the at least one blocked stormwater inlet and the at least one unblocked stormwater inlet based on the real-time water accumulation data of the stormwater inlets in a plurality of ways.

In some embodiments, the emergency supervision management platform may determine a blockage threshold corresponding to the stormwater inlets based on vegetation data of the stormwater inlets, environmental data, and current meteorological data; and determine the at least one blocked stormwater inlet and the at least one unblocked stormwater inlet based on the blockage threshold and the real-time water accumulation data of the stormwater inlets.

The vegetation data refers to data related to plant communities around the stormwater inlet. For example, vegetation type, vegetation quantity, or the like. In some embodiments, the emergency supervision management platform may obtain the vegetation data through traffic monitoring cameras near the stormwater inlet.

In some embodiments, a larger vegetation quantity indicates a higher blockage risk of the stormwater inlet. The blockage risk refers to a probability that the stormwater inlet is blocked due to accumulation of debris in the stormwater inlet.

The environmental data refers to related information about human activities and land use characteristics around the stormwater inlet. In some embodiments, the environmental data may include a crowd density and a region type. The crowd density refers to a count of people passing the stormwater inlet per unit time. The region type refers to a functional attribute and a land use nature of a region in urban planning. For example, a commercial region, a residential region, an industrial region, or the like.

In some embodiments, a larger crowd density indicates a larger amount of garbage/sewage discharge and a higher blockage risk of the stormwater inlet. In some embodiments, an amount of garbage/sewage discharge in a commercial region is larger than an amount of garbage/sewage discharge in a residential region.

The current meteorological data refers to real-time data obtained to describe an instantaneous atmospheric condition of a specific location or region. For example, precipitation, temperature, humidity, wind speed, or the like. In some embodiments, the emergency supervision management platform may obtain the current meteorological data from a third-party platform such as a weather station.

In some embodiments, a worse atmospheric condition (e.g., heavy rainfall or strong wind) indicates a higher blockage risk of the stormwater inlet.

The blockage threshold refers to a critical reference value used to determine whether the stormwater inlet is blocked. In some embodiments, the blockage threshold may be preset manually.

In some embodiments, the blockage threshold may be determined through steps 1-3 below.

Step 1, determining a baseline blockage threshold.

The baseline blockage threshold refers to a critical value for blockage determination serving as an initial reference standard. In some embodiments, the baseline blockage threshold may be preset by a user. More frequent occurrence of blockage of the stormwater inlet indicates more residual debris that is not completely cleaned in a pipeline and a higher risk of blockage again. In some embodiments, the emergency supervision management platform may subtract a count of times the stormwater inlet is blocked in historical data from a user preset value to obtain a smaller baseline blockage threshold.

Step 2, determining a vegetation coefficient, an environmental coefficient, and a meteorological coefficient, respectively, based on the vegetation data, the environmental data, and the current meteorological data.

The vegetation coefficient refers to a value used to assess a potential risk level of a plant community around the stormwater inlet causing blockage of the stormwater inlet. In some embodiments, a larger vegetation coefficient indicates denser vegetation around the stormwater inlet, more debris generated by the vegetation, and a higher blockage risk of the stormwater inlet.

In some embodiments, the vegetation coefficient may be determined based on a vegetation type coefficient and a vegetation quantity. For example, the vegetation coefficient may be calculated by the following formula (1):

$${C}_{V} = α * N . \qquad ( 1 )$$

In formula (1), C_{V} denotes the vegetation coefficient; α denotes the vegetation type coefficient; and N denotes the vegetation quantity. The vegetation type coefficient may be preset manually. For example, a vegetation type coefficient for a deciduous tree is 0.05; a vegetation type coefficient for a shrub is 0.01.

The environmental coefficient refers to a value used to assess a potential risk level of blockage of the stormwater inlet caused by human socioeconomic activities in an region where the stormwater inlet is located. In some embodiments, a larger environmental coefficient indicates more people around the stormwater inlet, more garbage generated, and a higher blockage risk of the stormwater inlet.

In some embodiments, the environmental coefficient is determined based on a region coefficient and a population density. For example, the environmental coefficient may be calculated by the following formula (2):

$${C}_{e} = β * D . \qquad ( 2 )$$

In formula (2), Cₑ is the environmental coefficient; β is the region coefficient; and D is the population density. The region coefficient may be preset manually. For example, a region coefficient for a residential region is 0.003; a region coefficient for a commercial region is 0.008.

The meteorological coefficient refers to a value used to assess a potential risk level of blockage of the stormwater inlet caused by current weather conditions in an area where the stormwater inlet is located. In some embodiments, the meteorological coefficient may be obtained by calculation based on an actual rainfall amount, a wind speed, a reference rainfall amount, and a reference wind speed. For example, the meteorological coefficient may be calculated by the following formula (3):

$${C}_{M} = \frac{P}{{P}_{0}} + \frac{V}{{V}_{0}} . \qquad ( 3 )$$

In formula (3), C_{M} is the meteorological coefficient, P is the rainfall amount, P₀ is the reference rainfall amount, V is the wind speed, and V₀ is the reference wind speed. The reference rainfall amount and the reference wind speed are preset manually.

Step 3, adjusting the baseline blockage threshold corresponding to the stormwater inlet to determine a blockage threshold.

In some embodiments, the blockage threshold may be calculated by the following formula (4):

$$C T = C {T}_{0} * ( 1 - {C}_{V} - {C}_{e} - {C}_{M} ) . \qquad ( 4 )$$

In formula (4), CT is the blockage threshold, with a dimension of cm; CT₀ is the baseline reference blockage threshold, with a dimension of cm; C_{V} is the vegetation coefficient; Cₑ is the environmental coefficient; and C_{M} is the meteorological coefficient.

Merely by way of example, when the baseline blockage threshold is 15 cm, for a stormwater inlet in no wind and no rain conditions with sparse surrounding vegetation, the emergency supervision management platform adjusts the blockage threshold of the stormwater inlet to 10 cm. For a stormwater inlet in windy weather and heavy rain conditions with a large count of surrounding trees, the emergency supervision management platform dynamically lowers the blockage threshold to 5 cm to predict potential blockage in advance.

In some embodiments, the emergency supervision management platform may determine the at least one blocked stormwater inlet and the at least one unblocked stormwater inlet based on the blockage threshold and the real-time water accumulation data. For example, when a water accumulation height in the real-time water accumulation data of the stormwater inlet is higher than the blockage threshold, the stormwater inlet is determined to be a blocked stormwater inlet. Otherwise, the stormwater inlet is determined to be an unblocked stormwater inlet.

In some embodiments of the present disclosure, the emergency supervision management platform dynamically adjusts the blockage threshold based on the vegetation data, the environmental data, and the current meteorological data, avoiding judgment using a fixed and uniform standard, which can more accurately identify actual blockage caused by water accumulation and reduce false alarms.

Step 220, acquiring a water accumulation data sequence of the at least one blocked stormwater inlet, and determining a water accumulation growth feature of the at least one blocked stormwater inlet based on the water accumulation data sequence.

The water accumulation data sequence refers to a sequence formed by real-time water accumulation data collected for a stormwater inlet in chronological order over a continuous time period.

In some embodiments, the water accumulation data sequence may be continuously collected by a water accumulation sensor deployed at the stormwater inlet and uploaded to the emergency supervision management platform.

The water accumulation growth feature refer to a dynamic indicator used to describe change in water accumulation over time.

In some embodiments, the water accumulation growth feature include a water accumulation area growth rate, a water accumulation depth growth rate, or the like.

In some embodiments, the emergency supervision management platform may determine the water accumulation growth feature of the at least one blocked stormwater inlet through a mathematical manner based on a water accumulation data sequence of each blocked stormwater inlet within a preset time period in historical data. The preset time period is preset based on human experience. For example, the preset time period may be 5 minutes, 20 minutes, 30 minutes, etc. The mathematical manner includes linear regression, time series analysis, or the like.

Merely by way of example, the water accumulation depth of the blocked stormwater inlet increases from 5 cm to 10 cm in the past 5 minutes, then the water accumulation depth growth rate of the blocked stormwater inlet is 1 cm/minute.

Step 230, determining a first cleaning point and a first priority level corresponding to the first cleaning point based on the water accumulation growth feature.

The first cleaning point refers to a stormwater inlet that has been blocked and needs cleaning.

The first priority level refers to a response level for a disposal sequence of the first cleaning point.

In some embodiments, the emergency supervision management platform may classify a level category of the first priority level based on the water accumulation growth feature of the first cleaning point. For example, the level category includes Level 1—highest, Level 2—urgent, Level 3—priority, etc.

In some embodiments, the emergency supervision management platform determines the blocked stormwater inlet as the first cleaning point.

In some embodiments, the emergency supervision management platform may determine the first priority level corresponding to the first cleaning point based on the water accumulation growth feature of the first cleaning point and a first priority level preset table. The first priority level preset table includes a numerical range of the water accumulation growth feature and a corresponding level category of the first priority level. The first priority level preset table may be constructed by a technician based on a large amount of historical data. For example, a larger numerical value in the numerical range of the water accumulation growth feature corresponds to a higher level category of the priority level.

Step 240, determining a blockage probability distribution of the at least one unblocked stormwater inlet; and determining a second cleaning point based on the blockage probability distribution.

The blockage probability distribution refers to a distribution of probabilities of blockage occurring at the unblocked stormwater inlets.

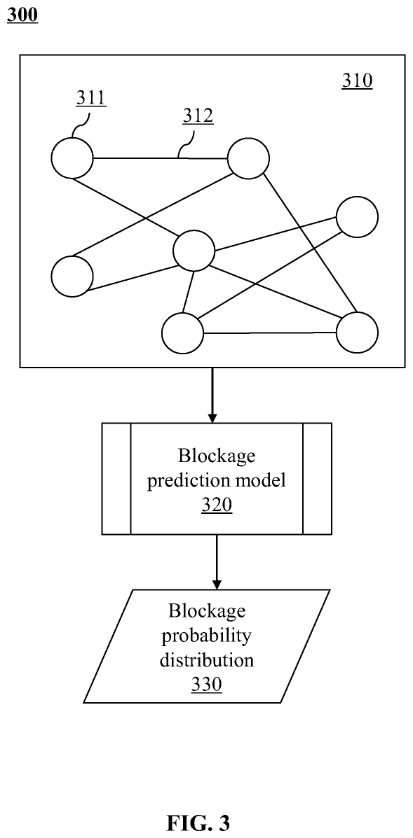

In some embodiments, the emergency supervision management platform may determine the blockage probability distribution of the at least one unblocked stormwater inlet based on a blockage prediction model. More descriptions regarding a determination manner of the blockage probability distribution of the at least one unblocked stormwater inlet may be found in FIG. 3 and related descriptions.

The second cleaning point refers to an unblocked stormwater inlet with a high risk of blockage.

In some embodiments, the emergency supervision management platform may determine the second cleaning point based on the blockage probability distribution. In some embodiments, in response to determining that a blockage probability of the unblocked stormwater inlet is greater than a preset risk threshold, the emergency supervision management platform determines the unblocked stormwater inlet as the second cleaning point. The preset risk threshold may be set based on technician experience. More descriptions regarding the blockage probability distribution may be found in FIG. 3 and related descriptions.

Step 250, generating a cleaning instruction based on the first cleaning point, the first priority level, and the second cleaning point, and controlling an autonomous cleaning machine to move along the cleaning path based on the cleaning instruction, and performing cleaning on stormwater inlets corresponding to the first cleaning point and the second cleaning point respectively based on the cleaning sequence.

More descriptions regarding the autonomous cleaning machine may be found in corresponding descriptions in FIG. 1.

The cleaning path refers to an optimal route for the autonomous cleaning machine to start from a current position and clean all the first cleaning points and the second cleaning points.

The cleaning sequence refers to a sequence for cleaning the first cleaning point and the second cleaning point.

In some embodiments, the emergency supervision management platform may generate the cleaning instruction through a path planning algorithm based on the first cleaning point, the first priority level corresponding to the first cleaning point, and the second cleaning point. The path planning algorithm may be a greedy algorithm, a genetic algorithm, a rapidly-exploring random tree, a vehicle routing problem algorithm, or the like.

Taking the vehicle routing problem algorithm as an example, the emergency supervision management platform treats the autonomous cleaning machine as a vehicle, treats the first cleaning point and the second cleaning point as algorithm customer points, treats the first priority level of the first cleaning point and the blockage probability of the unblocked stormwater inlet as weights set for the first cleaning point and the second cleaning point in the algorithm, respectively; further performs, based on the vehicle, the algorithm customer points, and the weights, path planning through the vehicle routing problem algorithm to obtain the cleaning path. The weight refers to an urgency and importance of a cleaning task for the stormwater inlet corresponding to the cleaning point. A larger weight indicates a more severe blockage situation or a higher potential risk of the stormwater inlet, and a higher processing priority of the stormwater inlet in the cleaning path and the cleaning sequence generated by the system. In some embodiments, the weight of the first cleaning point is greater than the weight of the second cleaning point.

In some embodiments, the cleaning instruction is executed by the autonomous cleaning machine. In some embodiments, the emergency supervision object platform controls the autonomous cleaning machine to move along the cleaning path, and cleans stormwater inlets corresponding to the first cleaning point and the second cleaning point, respectively, based on the cleaning sequence. In some embodiments, the autonomous cleaning machine cleans the first cleaning points in an order sorted by a magnitude of the first priority level, and then cleans the second cleaning points in an order sorted by a magnitude of the blockage probability.

In some embodiments of the present disclosure, by analyzing the blockage probability distribution of the at least one unblocked stormwater inlet, potential risk points (the second cleaning points) are identified; for stormwater inlets that have been blocked (the first cleaning points), an emergency degree of disaster development is accurately determined by analyzing the water accumulation growth feature of the stormwater inlets. Such a globally optimized strategy ensures efficient utilization of limited emergency resources, improves an emergency response speed and a resource utilization efficiency, is conducive to restoring urban drainage functions in a short time, and curbs an expansion of water accumulation disasters.

FIG. 3 is a schematic diagram illustrating an exemplary blockage prediction model according to some embodiments of the present disclosure.

In some embodiments, the emergency supervision management platform is further configured to: determine at least one associated stormwater inlet and an association feature corresponding to the at least one associated stormwater inlet based on urban pipe network data and location information of the stormwater inlets; construct a drainage graph 310 based on real-time image data of the stormwater inlets, the real-time water accumulation data of the stormwater inlets, future meteorological data of the stormwater inlets, and the at least one associated stormwater inlet and the association feature; and predict the blockage probability distribution 330 of the at least one unblocked stormwater inlet through a blockage prediction model 320 based on the drainage graph 310, the blockage prediction model 320 being a machine learning model. More descriptions regarding the real-time image data, the real-time water accumulation data, the future meteorological data, the associated stormwater inlet, and the corresponding association feature may be found in related descriptions in the preceding and following text.

The urban pipe network data refers to structural data describing a physical structure, connection relationships, and topological attributes of an urban underground drainage system. In some embodiments, the emergency supervision management platform 130 extracts the urban pipe network data from a geographic information system (GIS).

The location information of the stormwater inlet refers to a geographical identifier of the stormwater inlet in an urban space, and may include absolute coordinates and a relative topological position. In some embodiments, the location information of the stormwater inlet may be obtained from a geographic information database, or obtained through image recognition and GIS matching.

The associated stormwater inlet refers to a set of other stormwater inlets that are physically connected to or spatially adjacent to a current stormwater inlet. For example, the associated stormwater inlet may be a stormwater inlet connected to the current stormwater inlet through a pipeline or located in a common region.

The association feature refers to a relational attribute formed between stormwater inlets in a drainage system due to physical connections or spatial positions, which is used to describe a mutual influence and a drainage path between the stormwater inlets.

In some embodiments, the association feature may include upstream, downstream, or being located within a same blockage-prone region.

In some embodiments, the associated stormwater inlet may be determined based on a physical pipeline topology. For example, if two stormwater inlets are directly connected via a pipeline, i.e., forming a physical connection relationship, the two stormwater inlets are associated stormwater inlets to each other, and the physical connection relationship is determined as an association feature of the two stormwater inlets.

In some embodiments, the associated stormwater inlet may be determined based on a spatial location. For example, a plurality of stormwater inlets are distributed within a preset spatial range, a stormwater inlet located within the preset spatial range is determined as an associated stormwater inlet, and the spatial location may be determined as an association feature of the associated stormwater inlet.

The real-time image data refers to image data of a stormwater inlet and a surrounding environment acquired in real time. In some embodiments, the real-time image data may include a physical state of the stormwater inlet, for example, data such as an open/closed state, whether the stormwater inlet is blocked by a foreign object, and a water accumulation area.

In some embodiments, a technician may install a high-definition camera above the stormwater inlet to acquire the real-time image data of the stormwater inlet and a surrounding range in real time by periodically capturing image information.

The future meteorological data refers to meteorological element prediction information covering a future specific time period (e.g., 3 hours to 72 hours), derived based on weather forecasts or historical meteorological patterns. In some embodiments, the future meteorological data may include parameters such as precipitation, temperature, and wind force for the future specific time period.

In some embodiments, a technician may determine required future meteorological data by accessing a meteorological service interface, using a pre-trained prediction model, or performing real-time monitoring of meteorological data.

The drainage graph 310 refers to a digital analysis framework of the system for emergency supervision of stormwater inlets in the smart city based on an IoT large model 100 modeled based on a graph structure, and the drainage graph 310 includes nodes 311 and edges 312.

In some embodiments, the drainage graph 310 may include multi-dimensional information such as the real-time image data, the real-time water accumulation data, the future meteorological data, and geographical coordinates.

In some embodiments, the emergency supervision management platform 130 may use each stormwater inlet as a node, use data such as the real-time image data of the stormwater inlet, the real-time water accumulation data of the stormwater inlet, the future meteorological data of the stormwater inlet, and the geographical coordinates of the stormwater inlet as node features, and simultaneously, according to a road to which the node belongs, connect different nodes having a connectivity relationship with an edge, use a distance, a direction, and a length of a stormwater flow path as edge features, and then construct the drainage graph 310.

The future meteorological data of the stormwater inlet refers to meteorological data of an region where the stormwater inlet is located within a future preset time period.

In some embodiments, the emergency supervision management platform 130 may update the drainage graph 310 by updating the node features at a preset period. For example, the emergency supervision management platform 130 updates the real-time image data corresponding to the node features with target image data reshot by a UAV, and updates the drainage graph 310 by updating the real-time water accumulation data, the future meteorological data, the geographical coordinates, etc. corresponding to the node features.

In some embodiments, the emergency supervision management platform 130 may adjust the preset period according to a change amplitude of the real-time water accumulation data or a change amplitude of real-time meteorological data.

In some embodiments, the adjusted preset period may be determined by the following formula (5):

$${P}_{a} = \frac{{P}_{h}}{{C}_{r} + 1} . \qquad ( 5 )$$

In formula (5), Pₐ is the adjusted preset period, Pₕ is a historical preset period, and Cᵣ is a change amplitude.

In some embodiments, when Cᵣ+1=0, it indicates that the water accumulation has been cleared at this time, and the preset period is no longer adjusted.

In some embodiments, the change amplitude of the real-time water accumulation data may be determined through statistical analysis of data acquired by a water accumulation sensor; the change amplitude of the real-time meteorological data may be determined through statistical analysis based on real-time detected meteorological data.

More descriptions regarding the blockage prediction model may be found in the following description of the blockage prediction model and related descriptions.

The drainage graph 310 includes the nodes 311 and the edges 312; the nodes 311 correspond to the stormwater inlets, the edges 312 represent the association feature between the nodes, and edge features include a distance and a direction of a stormwater flow path between the nodes connected by an edge.

The node 311 refers to a basic unit in the drainage graph, and each node 311 corresponds to a single stormwater inlet. In some embodiments, the emergency supervision management platform 130 may set the stormwater inlets with a distance less than or equal to a preset distance threshold as one node 311. For example, the emergency supervision management platform 130 performs cluster analysis on a plurality of stormwater inlets, divides the stormwater inlets with a physical distance between the stormwater inlets less than or equal to the preset distance threshold into a same cluster, and sets the stormwater inlets in the same cluster as one node 311.

The node features refer to a digital attribute set of nodes in the drainage graph. In some embodiments, the node features include at least one of the real-time image data of the stormwater inlet corresponding to the node 311, the real-time water accumulation data of the stormwater inlet corresponding to the node, the future meteorological data of the stormwater inlet corresponding to the node, and geographical coordinates of the stormwater inlet corresponding to the node.

In some embodiments, the node features may further include a blockage state of the stormwater inlet. The blockage state of the stormwater inlet may include blocked and unblocked.

In some embodiments, the node features of the drainage graph 310 further include vegetation data of the stormwater inlet and environmental data.

In some embodiments, the environmental data further includes a sediment exposure feature for characterizing a sediment exposure condition around the stormwater inlet. For example, the sediment exposure feature may be a sediment exposure area; more sediment exposure may indicate more severe sediment loss, and the stormwater inlet may be more prone to blockage by silt and sand particles.

In some embodiments, the sediment exposure feature may be acquired through monitoring data or construction data. For example, the emergency supervision management platform 130 may determine the sediment exposure feature based on a ratio of an area of exposed sediment ground to an area of the stormwater inlet in an image.

In some embodiments, the emergency supervision management platform 130 may determine the sediment exposure feature by associating the node features and the edge features corresponding to each stormwater inlet in the drainage graph 310. For example, the emergency supervision management platform 130 determines an upstream catchment region corresponding to the stormwater inlet based on a stormwater flow direction characterized by the edge features of the drainage graph 310, and calculates a ratio of a total area of exposed sediment ground within the upstream catchment region of the stormwater inlet to an area of the stormwater inlet itself as the sediment exposure feature.

More descriptions regarding the vegetation data and the environmental data may be found in step 210 and related descriptions.

The edge 312 refers to a virtual relationship connecting adjacent stormwater inlet nodes, and the edge 312 characterizes association features between nodes corresponding to the stormwater inlets.

In some embodiments, the emergency supervision management platform 130 may determine the edge 312 between different nodes according to a road to which the node belongs. For example, the adjacent stormwater inlets belonging to a same road may be connected by the edge 312; adjacent stormwater inlets not belonging to a same road but connected via a pipeline or a ditch may also be connected by the edge 312.

The edge features refer to a distance and a direction of the stormwater flow path, where the distance may be a length of a pipeline or a ditch, etc., and the direction is the flow of stormwater from upstream to downstream along the flow path.

In some embodiments, the edge features may further include association features between nodes, for example, the association features such as the stormwater inlets corresponding to nodes being located in a same blockage-prone region, being located upstream or downstream of a road, etc.

Some embodiments of the present disclosure achieve full-dimensional digital modeling of an urban drainage system by integrating the real-time image data, the water accumulation data, the future meteorological data, and the geographical coordinates of the stormwater inlet, optimize a path planning efficiency of the autonomous cleaning machine, and improve an intelligence level of urban flood prevention emergency response.

Some embodiments of the present disclosure enable the emergency supervision management platform 130 to identify dynamic blockage-inducing factors such as fallen leaves and sediment accumulation by introducing the vegetation data and the environmental data of the stormwater inlet into the node features of the drainage graph 310, and dynamically optimize the blockage prediction model 320 in combination with real-time meteorological data, thereby improving an allocation efficiency of autonomous cleaning tasks and reducing misjudgments caused by environmental interference.

The blockage prediction model 320 refers to a model for determining a blockage probability distribution of the stormwater inlet, and the blockage prediction model may be a machine learning model, for example, one or a combination of a graph neural network (GNN) model or other custom models.

In some embodiments, an input of the blockage prediction model 320 may be the dynamically updated drainage graph 310, and an output of the blockage prediction model 320 may be a blockage probability distribution 330 of each unblocked stormwater inlet in the future.

In some embodiments, the emergency supervision management platform 130 may determine a blockage probability of each unblocked stormwater inlet in the future based on the output blockage probability distribution 330. For example, when the output result shows that “the probability of severe blockage is 20%, the probability of ordinary blockage is 20%, and the probability of no blockage is 60%”, the probability that the unblocked stormwater inlet will not be blocked in the future may be determined as 60%.

In some embodiments, the blockage prediction model 320 may be obtained by training with a large count of training samples with training labels. The training samples include sample drainage graphs constructed based on historical blockage data. The training labels corresponding to the training samples include blockage probabilities obtained based on statistics of historical blockage results corresponding to nodes in the sample drainage graph.

During training, the training samples are input into an initial blockage prediction model. A loss function is constructed based on outputs of the initial blockage prediction model and the labels. Parameters of the initial blockage prediction model are iteratively updated based on the loss function until a preset training condition is met. Training ends, and the trained blockage prediction model 320 is obtained. The preset training condition may include, but is not limited to, convergence of the loss function, a training cycle reaching a threshold, or the like.

Some embodiments of the present disclosure construct a drainage graph by integrating urban pipe network topology data, geographical locations of stormwater inlets, and surrounding environmental features, and utilizes a machine learning model to dynamically predict a blockage probability distribution of unblocked stormwater inlets in combination with real-time image data, real-time water accumulation data, and future meteorological data, significantly improving accuracy of blockage risk identification and scientificity of emergency resource scheduling.

In some embodiments, the emergency supervision management platform 130 is further configured to: generate a reshooting instruction based on real-time image data and real-time water accumulation data of a candidate stormwater inlet; wherein the candidate stormwater inlet is an unblocked stormwater inlet whose blockage probability distribution 330 satisfies a preset condition, and the reshooting instruction includes a shooting angle and a focal length; and control a UAV to collect target image data of the candidate stormwater inlet at the shooting angle and the focal length based on the reshooting instruction; and re-determine the blockage probability distribution 330 of the candidate stormwater inlet based on the target image data and the real-time water accumulation data.

The candidate stormwater inlet refers to a stormwater inlet that has not been blocked, but whose blockage probability distribution 330 obtained through the blockage prediction model 320 based on the drainage graph 310 satisfies the preset condition. In some embodiments, for the candidate stormwater inlet, a UAV is required to reshoot image data to re-determine the blockage probability distribution 330 of the candidate stormwater inlet.

In some embodiments, the blockage probability distribution 330 satisfies the preset condition when the blockage probability distribution 330 output by the blockage prediction model 320 cannot clearly determine a future blockage probability of the unblocked stormwater inlet. For example, when the output result of the blockage prediction model 320 shows that “the probability of severe blockage is 40%, the probability of ordinary blockage is 40%, and the probability of no blockage is 20%”, the probability values are relatively close, and a clear judgment cannot be made, then the blockage probability distribution 330 of the unblocked stormwater inlet satisfies the preset condition at this time.

In some embodiments, the blockage probability distribution 330 of the unblocked stormwater inlet obtained through the drainage graph 310 and the blockage prediction model 320 satisfies the preset condition, indicating that the blockage probability distribution 330 of the unblocked stormwater inlet is in a fuzzy state, and the unblocked stormwater inlet needs to be determined as the candidate stormwater inlet.

More descriptions regarding the blockage prediction model 320 may be found in the foregoing description related to the blockage prediction model 320.

The reshooting instruction refers to a control instruction automatically generated by the emergency supervision management platform 130 when the emergency supervision management platform 130 determines that the unblocked stormwater inlet is the candidate stormwater inlet. The reshooting instruction is generated based on specific situations such as a geographical location and surrounding environmental features of the candidate stormwater inlet. The reshooting instruction is used to control the UAV to perform image collection of the candidate stormwater inlet at a specific shooting angle and a specific focal length to supplement corresponding data, improving accuracy of blockage probability prediction. The shooting angle may include top-down shooting from directly above the stormwater inlet at a preset angle or side shooting. The focal length may include a wide angle or a medium focal length.

In some embodiments, the reshooting instruction may include the shooting angle and the focal length. For example, the reshooting instruction includes requiring the UAV to adjust to a side view of 45° and a wide-angle focal length of 24 mm, and to circle to shoot multiple panoramic images.

In some embodiments, the reshooting instruction includes UAV shooting parameters such as the shooting angle and the focal length corresponding to the stormwater inlet, providing data support for blockage prediction and emergency decision-making.

In some embodiments, if the emergency supervision management platform 130 determines that the unblocked stormwater inlet is the candidate stormwater inlet, the emergency supervision management platform 130 may automatically generate a corresponding reshooting instruction based on specific situations and data of the candidate stormwater inlet.

In some embodiments, the emergency supervision management platform 130 is configured to send the generated reshooting instruction to an emergency supervision object platform 150. The UAV obtains the target image data of the candidate stormwater inlet based on the reshooting instruction after receiving the reshooting instruction, and the UAV transmits the collected image data back to the emergency supervision management platform 130.

The target image data is image data collected by the UAV for the candidate stormwater inlet based on the reshooting instruction. The target image data is used to supplement or correct deficiencies of original real-time image data to improve accuracy of blockage probability prediction.

In some embodiments, the emergency supervision management platform 130 updates node features by combining the target image data obtained through UAV reshooting with data such as the real-time water accumulation data, the future meteorological data, the vegetation data, environmental data, and the association features, re-predicts a blockage probability using the blockage prediction model 320, and re-determines the blockage probability distribution 330 of the candidate stormwater inlet.

More descriptions regarding the blockage prediction model 320 may be found in the foregoing related descriptions.

More descriptions regarding the blockage probability distribution 330 may be found in the foregoing step 240 and related descriptions.

Some embodiments of the present disclosure perform image collection for the candidate stormwater inlet whose blockage probability is in an uncertain state through the UAV to obtain the target image data, dynamically correct the node features, and re-determine the blockage probability distribution of the candidate stormwater inlet, improving accuracy of blockage probability prediction for the stormwater inlet.

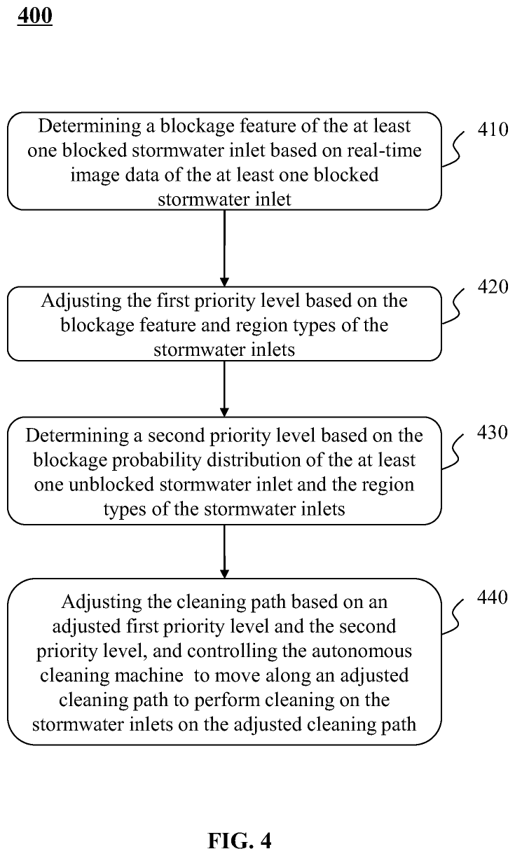

FIG. 4 is a flowchart illustrating an exemplary process for adjusting a cleaning path according to some embodiments of the present disclosure.

Step 410, determining a blockage feature of the at least one blocked stormwater inlet based on real-time image data of the at least one blocked stormwater inlet.

The blockage feature refer to attributes of a blockage object reflected by the real-time image data of the blocked stormwater inlet. In some embodiments, the blockage feature may include information such as a blockage object type, a blockage degree, and a blockage object coverage rate.

In some embodiments, the blockage object type may include fallen leaves, plastic, or silt. The blockage degree may include complete blockage or partial blockage. The blockage object coverage rate refers to an area proportion of the blockage object covering the stormwater inlet.

In some embodiments, the emergency supervision management platform 130 is configured to perform image recognition or type analysis on the blocked stormwater inlet using a computer vision model based on the real-time image data of the blocked stormwater inlet to determine the blockage object type and the blockage degree, calculate a coverage area of the blockage object on a grate of the stormwater inlet, and convert the coverage area into a coverage percentage, so as to determine the blockage feature.

Step 420, adjusting the first priority level based on the blockage feature and region types of the stormwater inlets.

The region type of the stormwater inlet refers to an attribute category divided based on factors such as an urban function, traffic importance, and historical risks of a location where the stormwater inlet is located. The region type is used to evaluate potential impact of blockage and determine a cleaning priority level.

In some embodiments, the region type may include types such as a residential region, a commercial region, a main traffic artery region, a flood-prone region, or the like.

In some embodiments, the emergency supervision management platform 130 is configured to adjust the first priority level of the blocked stormwater inlet through a priority database based on the blockage feature and the region type of the blocked stormwater inlet.

In some embodiments, the emergency supervision management platform 130 may adjust the first priority level of the blocked stormwater inlet according to the region type. For example, for a stormwater inlet located in a commercial area, the emergency supervision management platform 130 may increase the first priority level of the stormwater inlet by one level (e.g., increase a level from level two-urgent to level one-highest). A calculation manner for the priority level may be determined by a system according to requirements.

In some embodiments, the emergency supervision management platform 130 may adjust the first priority level of the blocked stormwater inlet according to the blockage object type. For example, for a stormwater inlet with a blockage object that requires a dedicated cleaning device (e.g., solidified cement, large tree roots, etc.), the emergency supervision management platform 130 may increase the first priority level of the stormwater inlet by one level.

In some embodiments, the emergency supervision management platform 130 may adjust the first priority level of the blocked stormwater inlet according to the blockage object coverage rate. For example, for a stormwater inlet with a high blockage object coverage rate, the emergency supervision management platform 130 may increase the first priority level of the stormwater inlet by one level. A determination standard for the high blockage object coverage rate may be determined by a technician according to requirements. For example, a stormwater inlet with a blockage object coverage rate greater than or equal to 60% is determined as the stormwater inlet with the high blockage object coverage rate.

In some embodiments, the priority database is generated by training historical data. The priority database stores optimal priority schemes corresponding to combinations of different blockage features and region types. The priority database includes a plurality of candidate vectors. Each candidate vector corresponds to a priority scheme combining the blockage features and the region type. The emergency supervision management platform 130 may construct a retrieval vector based on actual blockage features and the region type of the stormwater inlet. The retrieval vector is used to match with the candidate vectors in the database to obtain the optimal priority scheme.

In some embodiments, when adjusting the first priority level of the blocked stormwater inlet, the emergency supervision management platform 130 constructs the retrieval vector based on the blockage features of the blocked stormwater inlet and the region type of each stormwater inlet. The emergency supervision management platform 130 performs a search in the priority database based on the retrieval vector to determine a matched candidate vector. For example, a candidate vector with a shortest vector distance to the retrieval vector is determined as the matched candidate vector. A first priority level corresponding to the matched candidate vector is used as an adjusted first priority level of the blocked stormwater inlet.

More descriptions regarding the first priority level of the blocked stormwater inlet may be found in the foregoing step 230 and related descriptions.

Step 430, determining a second priority level based on the blockage probability distribution 330 of the at least one unblocked stormwater inlet and the region types of the stormwater inlets.

The second priority level of the unblocked stormwater inlet refers to a cleaning task priority level dynamically assessed for the unblocked stormwater inlet based on the blockage probability distribution 330 and the region type.

In some embodiments, the emergency supervision management platform 130 may divide the second priority level of the unblocked stormwater inlet into level categories based on the blockage probability distribution 330 and the region type. For example, the level categories may include level three-routine, level two-high risk, etc.

In some embodiments, the emergency supervision management platform 130 is configured to determine an initial second priority level for each unblocked stormwater inlet based on the blockage probability distribution 330. The emergency supervision management platform 130 subsequently determines a final second priority level for each unblocked stormwater inlet based on a region type where the unblocked stormwater inlet is located.

In some embodiments, the emergency supervision management platform 130 may generate an initial second priority level for each unblocked stormwater inlet based on the blockage probability distribution 330 of the unblocked stormwater inlet. The emergency supervision management platform 130 also pre-stores weight coefficients associated with different region types. For example, a weight coefficient for a main traffic route region is 1.5, and a weight coefficient for a residential region is 1.0. The emergency supervision management platform 130 calculates a final second priority level for each unblocked stormwater inlet by multiplying an initial priority score with a weight coefficient corresponding to the region type where the stormwater inlet is located.

Step 440, adjusting the cleaning path based on an adjusted first priority level and the second priority level, and controlling the autonomous cleaning machine to move along an adjusted cleaning path to perform cleaning on the stormwater inlets on the adjusted cleaning path.

In some embodiments, the emergency supervision management platform 130 further adjusts the cleaning path through a path optimization algorithm based on information such as the adjusted first priority level for the blocked stormwater inlet and the second priority level for the unblocked stormwater inlet, ensuring that high-priority tasks are processed first. The path optimization algorithm may include a vehicle routing problem (VRP) algorithm or the like.

More descriptions regarding the path planning algorithm and the cleaning path before adjustment may be found in FIG. 2 and related descriptions.

In some embodiments, the emergency supervision management platform 130 is configured to send information of the adjusted cleaning path to the emergency supervision object platform 150. The autonomous cleaning machine is controlled to execute a cleaning task based on the information of the adjusted cleaning path.

Some embodiments of the present disclosure achieve significant improvement in accuracy of emergency response and efficiency of resource scheduling, as well as dynamic adaptability of the system to complex and changing urban environments. This is achieved by introducing blockage features of stormwater inlets identified based on real-time image data, the blockage probability distribution 330, and the region type where the stormwater inlet is located to dynamically adjust task priorities for blocked stormwater inlets and unblocked stormwater inlets, and thereby optimizing the cleaning path in real time.

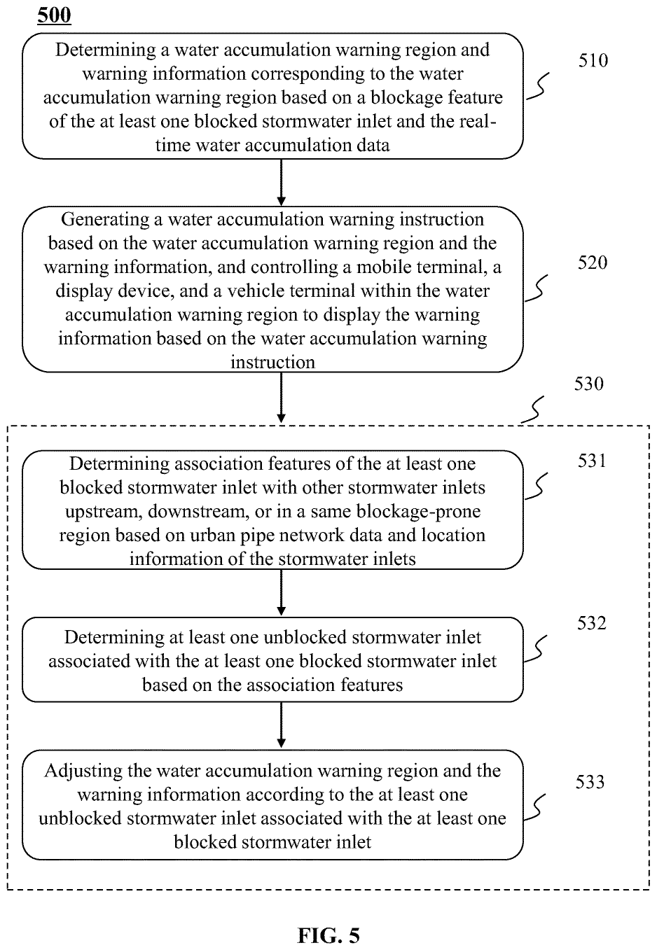

FIG. 5 is a flowchart illustrating an exemplary process for generating a warning instruction according to some embodiments of the present disclosure. As shown in FIG. 5, process 500 includes the following steps. In some embodiments, process 500 may be executed by the emergency supervision management platform.

Step 510, determining a water accumulation warning region and warning information corresponding to the water accumulation warning region based on a blockage feature of the at least one blocked stormwater inlet and the real-time water accumulation data.

The water accumulation warning region refers to an area with a high water accumulation risk centered on the stormwater inlet. For example, the water accumulation warning region may be a region within 5 meters around a stormwater inlet at an underpass tunnel, or an area within 3 meters around a stormwater inlet at a subway entrance.

The warning information refers to an alert notification about water accumulation risk issued to the public. In some embodiments, the warning information includes a water accumulation risk level, location information, traffic navigation prompts, etc. The water accumulation risk level refers to a degree of impact of water accumulation on the water accumulation warning region. The location information refers to a specific road section or region where water accumulation occurs. The traffic navigation prompt refers to the issuance of a detour route or travel advice to assist the public in avoiding risks.

In some embodiments, the emergency supervision management platform may determine a region within a preset radius around the stormwater inlet as the water accumulation warning region and determine corresponding warning information based on the blockage features of the blocked stormwater inlet and the real-time water accumulation data of the stormwater inlet. The preset radius may be set according to experience of technical personnel. More descriptions regarding the blockage features and the real-time water accumulation data may be found in related content of FIG. 1 and FIG. 4.

In some embodiments, when a water accumulation depth, a water accumulation area, and a blockage object coverage rate of the blocked stormwater inlet all show an upward trend, the emergency supervision management platform increases the preset radius, expands a scope of the water accumulation warning region, raises the water accumulation risk level of the warning information, and adjusts the traffic navigation prompt to strengthen traffic control measures. For example, the traffic navigation prompt may be adjusted from “reduce speed” to “no entry”. Conversely, the emergency supervision management platform reduces the scope of the water accumulation warning region, lowers the water accumulation risk level, and adjusts the traffic navigation prompt.

Step 520, generating a water accumulation warning instruction based on the water accumulation warning region and the warning information, and controlling a mobile terminal, a display device, and a vehicle terminal within the water accumulation warning region to display the warning information based on the water accumulation warning instruction.

The water accumulation warning instruction is an instruction for issuing a risk notification to terminals. In some embodiments, the water accumulation warning instruction includes the water accumulation warning region, the warning information, and a target terminal type to which the warning information needs to be sent. The target terminal type to which the warning information needs to be sent may be a mobile terminal, a display device, a vehicle terminal, etc.

The mobile terminal refers to portable smart devices such as smartphones and tablets, which receive the warning information through an application (APP) or a short message service (SMS). The display device refers to electronic bulletin boards, advertising screens, and traffic guidance screens in public places. The vehicle terminal refers to smart electronic devices built into or externally connected to a vehicle. For example, the vehicle terminal may be a vehicle radio or a vehicle navigation system.

In some embodiments, the emergency supervision management platform delineates the water accumulation warning region and generates the warning information based on the blockage features of the blocked stormwater inlet and the real-time water accumulation data of the stormwater inlet. The emergency supervision management platform identifies various types of terminal devices within the water accumulation warning region and synchronously publishes the warning information through a plurality of channels.

In some embodiments of the present disclosure, the water accumulation warning region and the warning information are dynamically generated through analysis of the blockage features and the real-time water accumulation data. The warning information is automatically sent synchronously to the mobile terminal, the display device, and the vehicle terminal within the region through the plurality of channels. This can reduce risks of traffic accidents and personal injuries, avoid traffic interruptions and congestion caused by water accumulation, and improve operational efficiency of urban traffic.

In some embodiments, the emergency supervision management platform may optionally execute step 530 to adjust the water accumulation warning region and the warning information. Step 530 includes the following steps 531 to 533.

Step 531, determining association features of the at least one blocked stormwater inlet with other stormwater inlets upstream, downstream, or in a same blockage-prone region based on urban pipe network data and location information of the stormwater inlets.

More descriptions regarding the urban pipe network data and the location information of the stormwater inlets may be found in FIG. 3 and related descriptions.

The blockage-prone region refers to a specific region or road section where stormwater inlets are prone to siltation and blockage due to natural or human factors, thereby causing a water accumulation risk. In some embodiments, the blockage-prone region may be a region where water accumulation occurred due to blockage of stormwater inlets in historical data.

In some embodiments, the emergency supervision management platform may determine association features between the blocked stormwater inlet and other stormwater inlets that are upstream, downstream, or in a same blockage-prone region based on the urban pipe network data and the location information of the stormwater inlets. A determination manner of the association features is similar to a manner of determining an associated stormwater inlet and association features corresponding to the associated stormwater inlet in FIG. 3. Specific content may be found in related descriptions above.

Step 532, determining at least one unblocked stormwater inlet associated with the at least one blocked stormwater inlet based on the association features.

The unblocked stormwater inlet associated with the blocked stormwater inlet refers to a neighboring stormwater inlet that has a hydraulic linkage relationship with the blocked stormwater inlet in a same drainage pipe network system. Although these stormwater inlets are not blocked, the stormwater inlets have a risk of blockage transmission because the stormwater inlets share a drainage branch pipe with the blocked stormwater inlet or are located downstream of a same catchment region. The hydraulic linkage relationship refers to a physical association formed between different facility units, such as stormwater inlets, in a same drainage pipe network system due to the shared water flow channel. The hydraulic linkage relationship enables the different facility units to mutually affect each other's water flow states, such as water level, flow velocity, and pressure. For example, stormwater inlets on a same drainage pipe have a hydraulic linkage relationship.

In some embodiments, the emergency supervision management platform may determine the unblocked stormwater inlet associated with the blocked stormwater inlet based on the association features through various manners.

In some embodiments, the emergency supervision management platform may determine the unblocked stormwater inlet associated with the blocked stormwater inlet based on a drainage graph. More descriptions regarding the drainage graph may be found in FIG. 3 and related descriptions.

In some embodiments, when a stormwater inlet is blocked and water accumulation occurs, the emergency supervision management platform determines an unblocked stormwater inlet that is downstream or in a same blockage-prone region based on nodes in the drainage graph, edges connected to the nodes, and adjacent nodes connected by the edges connected to the nodes. The same blockage-prone region refers to a geographical region that belongs to a same blockage region.

In some embodiments of the present disclosure, the unblocked stormwater inlets associated with the blocked stormwater inlets are identified through a drainage graph, achieving early warning of pipe network blockage risk transmission. This approach breaks through the limitations of traditional single-point monitoring and significantly improves the overall risk resistance capability of a drainage system.

Step 533, adjusting the water accumulation warning region and the warning information according to the at least one unblocked stormwater inlet associated with the at least one blocked stormwater inlet.

In some embodiments, the warning region is no longer limited to a region surrounding a blocked stormwater inlet. If a blocked stormwater inlet is associated with a downstream stormwater inlet of the blocked stormwater inlet, the emergency supervision management platform expands the warning region to include an region of the downstream stormwater inlet. The emergency supervision management platform adjusts the warning information to remind that the downstream stormwater inlet may have a water accumulation risk due to increased upstream water pressure.

In some embodiments of the present disclosure, dynamic adjustment of the water accumulation warning region and the warning information avoids unnecessary wide-area broadcasting, reduces information interference, and improves effectiveness of the warning. By combining with the unblocked stormwater inlets associated with a blocked stormwater inlet, downstream regions that may be affected by upstream blockage can be warned in advance, further improving a level of emergency management.

What is claimed is:

1. A system for emergency supervision of stormwater inlets in a smart city based on an Internet of Things (IoT) large model, comprising: an emergency supervision management platform, wherein the emergency supervision management platform is configured to:
determine at least one blocked stormwater inlet and at least one unblocked stormwater inlet based on real-time water accumulation data of the stormwater inlets;
acquire a water accumulation data sequence of the at least one blocked stormwater inlet, and determine a water accumulation growth feature of the at least one blocked stormwater inlet based on the water accumulation data sequence;
determine a first cleaning point and a first priority level corresponding to the first cleaning point based on the water accumulation growth feature;
determine a blockage probability distribution of the at least one unblocked stormwater inlet; and determine a second cleaning point based on the blockage probability distribution; and
generate a cleaning instruction based on the first cleaning point, the first priority level, and the second cleaning point, wherein the cleaning instruction includes a cleaning path and a cleaning sequence; and control an autonomous cleaning machine to move along the cleaning path based on the cleaning instruction, and perform cleaning on stormwater inlets corresponding to the first cleaning point and the second cleaning point respectively based on the cleaning sequence.

2. The system of claim 1, wherein the emergency supervision management platform is further configured to:
determine a blockage threshold of the stormwater inlets based on vegetation data of the stormwater inlets, environmental data, and current meteorological data; and
determine the at least one blocked stormwater inlet and the at least one unblocked stormwater inlet based on the blockage threshold and the real-time water accumulation data.

3. The system of claim 1, wherein the emergency supervision management platform is further configured to:
determine at least one associated stormwater inlet and an association feature corresponding to the at least one associated stormwater inlet based on urban pipe network data and location information of the stormwater inlets;
construct a drainage graph based on real-time image data of the stormwater inlets, the real-time water accumulation data of the stormwater inlets, future meteorological data of the stormwater inlets, and the at least one associated stormwater inlet and the association feature; and
predict the blockage probability distribution of the at least one unblocked stormwater inlet through a blockage prediction model based on the drainage graph, wherein the blockage prediction model is a machine learning model.

4. The system of claim 3, wherein the emergency supervision management platform is further configured to:
generate a reshooting instruction based on real-time image data and real-time water accumulation data of a candidate stormwater inlet; wherein the candidate stormwater inlet is an unblocked stormwater inlet whose blockage probability distribution satisfies a preset condition, and the reshooting instruction includes a shooting angle and a focal length; and control a unmanned aerial vehicle (UAV) to collect target image data of the candidate stormwater inlet at the shooting angle and the focal length based on the reshooting instruction; and
re-determine the blockage probability distribution of the candidate stormwater inlet based on the target image data and the real-time water accumulation data.

5. The system of claim 3, wherein the drainage graph includes nodes and edges; wherein
the nodes correspond to the stormwater inlets, and node features include at least one of the real-time image data of the stormwater inlet corresponding to the node, the real-time water accumulation data of the stormwater inlet corresponding to the node, the future meteorological data of the stormwater inlet corresponding to the node, and geographical coordinates of the stormwater inlet corresponding to the node; and
the edges represent the association feature between the nodes, and edge features include a distance and a direction of a stormwater flow path between the nodes connected by an edge.

6. The system of claim 5, wherein the node features of the drainage graph further include vegetation data of the stormwater inlet and environmental data.

7. The system of claim 3, wherein the emergency supervision management platform is further configured to:
determine a blockage feature of the at least one blocked stormwater inlet based on real-time image data of the at least one blocked stormwater inlet;
adjust the first priority level based on the blockage feature and region types of the stormwater inlets;
determine a second priority level based on the blockage probability distribution of the at least one unblocked stormwater inlet and the region types of the stormwater inlets; and
adjust the cleaning path based on an adjusted first priority level and the second priority level, and control the autonomous cleaning machine to move along an adjusted cleaning path to perform cleaning on the stormwater inlets on the adjusted cleaning path.

8. The system of claim 1, wherein the emergency supervision management platform is further configured to:
determine a water accumulation warning region and warning information corresponding to the water accumulation warning region based on a blockage feature of the at least one blocked stormwater inlet and the real-time water accumulation data; and
generate a water accumulation warning instruction based on the water accumulation warning region and the warning information, and control a mobile terminal, a display device, and a vehicle terminal within the water accumulation warning region to display the warning information based on the water accumulation warning instruction.

9. The system of claim 8, wherein the emergency supervision management platform is further configured to:
determine association features of the at least one blocked stormwater inlet with other stormwater inlets upstream, downstream, or in a same blockage-prone region based on urban pipe network data and location information of the stormwater inlets;
determine at least one unblocked stormwater inlet associated with the at least one blocked stormwater inlet based on the association features; and
adjust the water accumulation warning region and the warning information according to the at least one unblocked stormwater inlet associated with the at least one blocked stormwater inlet.

10. The system of claim 8, wherein the emergency supervision management platform is further configured to:
determine at least one unblocked stormwater inlet associated with the at least one blocked stormwater inlet based on a drainage graph.

11. A method for emergency supervision of stormwater inlets in a smart city, wherein the method is performed by an emergency supervision management platform of a system for emergency supervision of the stormwater inlets in the smart city based on an Internet of Things (IoT) large model, and the method comprises:
determining at least one blocked stormwater inlet and at least one unblocked stormwater inlet based on real-time water accumulation data of the stormwater inlets;
acquiring a water accumulation data sequence of the at least one blocked stormwater inlet, and determining a water accumulation growth feature of the at least one blocked stormwater inlet based on the water accumulation data sequence;
determining a first cleaning point and a first priority level corresponding to the first cleaning point based on the water accumulation growth feature;
determining a blockage probability distribution of the at least one unblocked stormwater inlet; and determining a second cleaning point based on the blockage probability distribution; and
generating a cleaning instruction based on the first cleaning point, the first priority level, and the second cleaning point, wherein the cleaning instruction includes a cleaning path and a cleaning sequence, and the cleaning instruction is configured to control an autonomous cleaning machine to move along the cleaning path and to perform cleaning on stormwater inlets corresponding to the first cleaning point and the second cleaning point respectively based on the cleaning sequence.

12. The method of claim 11, wherein the determining at least one blocked stormwater inlet and at least one unblocked stormwater inlet based on real-time water accumulation data of the stormwater inlet includes:
determining a blockage threshold of the stormwater inlets based on vegetation data of the stormwater inlets, environmental data, and current meteorological data; and
determining the at least one blocked stormwater inlet and the at least one unblocked stormwater inlet based on the blockage threshold and the real-time water accumulation data.

13. The method of claim 11, wherein the determining a blockage probability distribution of the at least one unblocked stormwater inlet includes:
determining at least one associated stormwater inlet and an association feature corresponding to the at least one associated stormwater inlet based on urban pipe network data and location information of the stormwater inlets;
constructing a drainage graph based on real-time image data of the stormwater inlets, the real-time water accumulation data of the stormwater inlet corresponding to the node, future meteorological data of the stormwater inlet corresponding to the node, the at least one associated stormwater inlet, and the association feature; and
predicting the blockage probability distribution of the at least one unblocked stormwater inlet through a blockage prediction model based on the drainage graph; wherein the blockage prediction model is a machine learning model.

14. The method of claim 13, wherein the method further includes:
generating a reshooting instruction based on real-time image data and real-time water accumulation data of a candidate stormwater inlet; wherein the candidate stormwater inlet is an unblocked stormwater inlet whose blockage probability distribution satisfies a preset condition, the reshooting instruction includes a shooting angle and a focal length, and the reshooting instruction is configured to control a unmanned aerial vehicle (UAV) to collect target image data of the candidate stormwater inlet at the shooting angle and the focal length; and
re-determining the blockage probability distribution of the candidate stormwater inlet based on the target image data and the real-time water accumulation data.

15. The method of claim 13, wherein the drainage graph includes nodes and edges; wherein
the nodes correspond to the stormwater inlets, and node features include at least one of the real-time image data of the stormwater inlet corresponding to the node, the real-time water accumulation data of the stormwater inlet corresponding to the node, the future meteorological data of the stormwater inlet corresponding to the node, and geographical coordinates of the stormwater inlet corresponding to the node; and
the edges represent the association features between the nodes, and edge features include a distance and a direction of a stormwater flow path between the nodes connected by an edge.

16. The method of claim 13, further comprising:
determining a blockage feature of the at least one blocked stormwater inlet based on the real-time image data of the at least one blocked stormwater inlet;
adjusting the first priority level based on the blockage feature and region types of the stormwater inlets;
determining a second priority level based on the blockage probability distribution of the at least one unblocked stormwater inlet and the region types of the stormwater inlets; and
adjusting the cleaning path based on an adjusted first priority level and the second priority level, and controlling the autonomous cleaning machine to move along an adjusted cleaning path to clean the stormwater inlet on the adjusted cleaning path.

17. The method of claim 11, further comprising:
determining a water accumulation warning region and warning information corresponding to the water accumulation warning region based on a blockage feature of the at least one blocked stormwater inlet and the real-time water accumulation data; and
generating a water accumulation warning instruction based on the water accumulation warning region and the warning information, wherein the water accumulation warning instruction is configured to control a mobile terminal, a display device, and a vehicle terminal within the water accumulation warning region to display the warning information.

18. The method of claim 17, further comprising:
determining association features of the at least one blocked stormwater inlet with other stormwater inlets upstream, downstream, or in a same blockage-prone region based on urban pipe network data and location information of the stormwater inlets;
determining at least one unblocked stormwater inlet associated with the at least one blocked stormwater inlet based on the association features; and
adjusting the water accumulation warning region and the warning information according to the at least one unblocked stormwater inlet associated with the at least one blocked stormwater inlet.

19. The method of claim 17, further comprising:
determining at least one unblocked stormwater inlet associated with the at least one blocked stormwater inlet based on a drainage graph.

20. A non-transitory computer-readable storage medium storing computer instructions, wherein when a computer reads the computer instructions in the storage medium, the computer executes the method for emergency supervision of stormwater inlets in a smart city according to claim 11.
